(19) United States
(12) Patent Application Publication
(10) Pub. No.: US 2015/0348049 A1
(43) Pub. Date: Dec. 3, 2015

(54) SYSTEMS AND METHODS FOR HOSPITALITY SERVICES USING BEACONS

(71) Applicant: EBAY INC., San Jose, CA (US)

(72) Inventors: Michael Charles Todasco, Santa Clara, CA (US); James Ross Skorupski, San Jose, CA (US)

(21) Appl. No.: 14/291,413

(22) Filed: May 30, 2014

(51) Int. Cl. G06Q 30/00; G06Q 10/02; H04W 40/24; G06Q 50/12; H04W 4/00; G06Q 30/02; G06Q 10/06

(52) U.S. Cl. CPC G06Q 30/016; G06Q 30/0261; G06Q 30/0267; G06Q 10/02; G06Q 30/0207; G06Q 10/0631; G06Q 50/12; H04W 4/008; H04W 40/244

(57) ABSTRACT

Systems and methods are provided for facilitating hotel services using beacons. Communications between a mobile device of a hotel guest and one or more beacons in or around the hotel may be used to determine the location of the hotel guest. Hotel services may be provided to the hotel guest based on the determined location and/or other information such as user preferences or calendar information. Hotel services may include hotel check-in or checkout, valet, housekeeping, purchasing, discounts, rewards, incentives, amenities adjustments, concierge, bell staff, or other services associated with hotel guests. Providing hotel services to hotel guests using locations determined using beacons may help improve a hotel guest experience by streamlining interactions with hotel staff and amenities and reducing the risk of inconveniences commonly experienced by hotel guests.

### TECHNICAL FIELD

The present invention generally relates to electronic commerce and, more particularly, to systems and methods for facilitating hospitality services using beacons.

### BACKGROUND

Hotel guests often face inconveniences when utilizing hotel services and amenities. For example, a guest desiring to check into a hotel room may encounter a long line at the front desk or a room that is not yet available for check in. Similar inconveniences can occur during the hotel stay or when leaving or checking out of the hotel. Because hotels are generally guest services oriented, it is undesirable for the hotel to allow these frustrations to occur and/or persist.

However, because of the limited capabilities of, and information available to hotel staff members in conventional systems, the hotel is often unaware of the user's arrival time, departure time, comings and goings, and it can therefore be difficult for the hotel to avoid potential or actual guest inconveniences.

It would therefore be desirable to be able to provide systems and methods for facilitating hospitality services.

### BRIEF DESCRIPTION OF THE DRAWINGS

FIG. 1 is a block diagram of an illustrative networked system suitable for implementing processes for facilitating hospitality services, according to an embodiment.

FIG. 2 is a diagram of an illustrative hotel having beacons, according to an embodiment.

FIG. 3 is a block diagram of an illustrative user device showing how a display of the user device may be used to provide alerts to a user regarding hotel check-in services, according to an embodiment.

FIG. 4 is a block diagram of an illustrative user device showing how a display of the user device may be used to provide alerts to a user regarding incentives related to hotel services, according to an embodiment.

FIG. 5 is a block diagram of an illustrative valet device showing how a display of the valet device may be used to provide alerts to a valet services worker regarding the location and/or status of a user, according to an embodiment.

FIG. 6 is a block diagram of an illustrative housekeeping device showing how a display of the housekeeping device may be used to provide information to a housekeeping services worker regarding the location and/or status of various hotel guests and/or guest rooms, according to an embodiment.

FIG. 7 is a flowchart of an exemplary process for providing efficient guest services using beacons, according to an embodiment.

FIG. 8 is a flowchart of an exemplary process showing further details of operations that may be performed for providing efficient guest services using beacons, according to an embodiment.

FIG. 9 is a flowchart of an exemplary process for providing efficient guest services within a hotel room using beacons, according to an embodiment.

FIG. 10 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Various locations provide equipment for communications with a user device of a user at the location. The equipment may include wireless communications equipment such as short range wireless communications equipment or other wireless communications equipment. The equipment may sometimes be referred to as beacon equipment or beacons. Wireless communications equipment that may be included in a beacon at a location may include Bluetooth Low Energy (BLE) beacon communications equipment, LTE Direct communications equipment, wireless local area network equipment (e.g., WiFi based equipment), cellular network equipment, global positioning system (GPS) equipment, combined cellular and GPS equipment, other radio or microwave based communications equipment, infrared communications equipment, and/or any combination thereof.

The beacons may communicate with the user device to alert users of various products and/or services. For example, beacons at hospitality location such as a hotel may communicate with the user device of a guest such as a hotel guest to alert the guest of check-in services, check-out services, valet services, room status alerts, incentives, rewards, product and/or service offers, other hospitality information and/or other products and services through their user device. The beacons may provide additional functionality, such as establishing a connection with a server entity to complete transactions including check-in services, check-out services, and/or provide guest location and/or status information to hotel staff such as front desk staff, concierge or bell staff, valet staff, housekeeping staff or other hotel systems and/or employees.

Additionally, the beacons may provide communication services to the user device directly, including information stored on the beacons, and/or information from a device or server corresponding to the beacon. One or more beacons may be used to determine (e.g., by triangulation operations) the location of a user at or near the hotel and/or within a hotel room to within, as examples, less than one meter, less than 10 feet, less than five feet, less than two feet, or less than one foot.

A service provider may include one or more locations where the service provider offers services such as hotel services and/or amenities and/or other goods, products, services, other hospitality services, and/or other items to users. The service location(s) may utilize short range wireless beacons to communicate with mobile user devices of the users. The short range wireless beacons may employ, for example, BLE communications that emit a signal receivable by a user device. The communication may include an identifier for the beacon. A user device may passively monitor for beacon communications such as BLE communications. When a user device detects a beacon signal such as a BLE signal and verifies the identifier as belonging to a particular location such as a hotel location (e.g., a hotel device and/or server), both the user device and the beacon may ramp up in power and establish a connection. The connection may further enable the user device to communicate with a service provider device and/or server. The beacon may be connected to a networked device at the service location, or the beacon may include network functionality to communicate with the service provider server.

The service provider may utilize an identifier from each user device to determine a user history and/or other information for the associated user. Thus, each user may receive targeted assistance based on the user history and other information, such as information about the service location and/or service provider, offers for help, product offers, service offers, incentives, rewards, and similar assistance or offers. For example, a hotel may provide hotel check-in services for a user. When the user's device checks into a hotel beacon, the hotel may access an account of the user, check the user into a hotel room, and a provide room number, location and/or status information to the user's device without the user having to wait in line or take any other hotel check in actions.

In another example, a hotel may provide valet parking services to hotel visitors and/or guests. Based on communications between a user's mobile device and one or more hotel beacons and/or a calendar event stored in the user's device, valet staff may receive notifications that the user is in need of their vehicle.

While a hotel guest is at the hotel, the location of the guest within the hotel may be determined (e.g., a location in the hotel lobby, a restaurant, or within the guest's hotel room). Notifications regarding products and/or services near the user's location may be provided and/or hotel amenities may be adjusted and/or controlled based on the user's location and, if desired, user preferences. For example, when a particular hotel guest is determined to be in a hotel room, the room temperature, lighting, television channel presets, hot water temperature, or other hotel amenities may be set according to that guest's preferences and/or other guest information. The guest's preferences may be provided by the guest or may be learned by a hotel computing system or payment provider system based on previous guest behavior. In one particular illustrative example, a user may wear a wearable device into a hotel shower and the shower temperature may be set for the user based on stored preferences for that user. In another illustrative example, a wearable device may include a temperature sensor that measures the skin temperature of the user and, based upon that measured temperature, adjusts the thermostat in a hotel room or other portion of a hotel to make the room the user is in hotter or colder (e.g., if the skin temperature of the user is determined to be below a threshold temperature, the thermostat can be adjusted to a higher temperature or if the skin temperature of the user is determined to be above a threshold temperature, the thermostat can be adjusted to a lower temperature).

Hotel room beacons may also be used for completing in-room purchases for hotel guests (e.g., based on short range communications between a mobile device of the hotel guest and a wireless beacon in the hotel room).

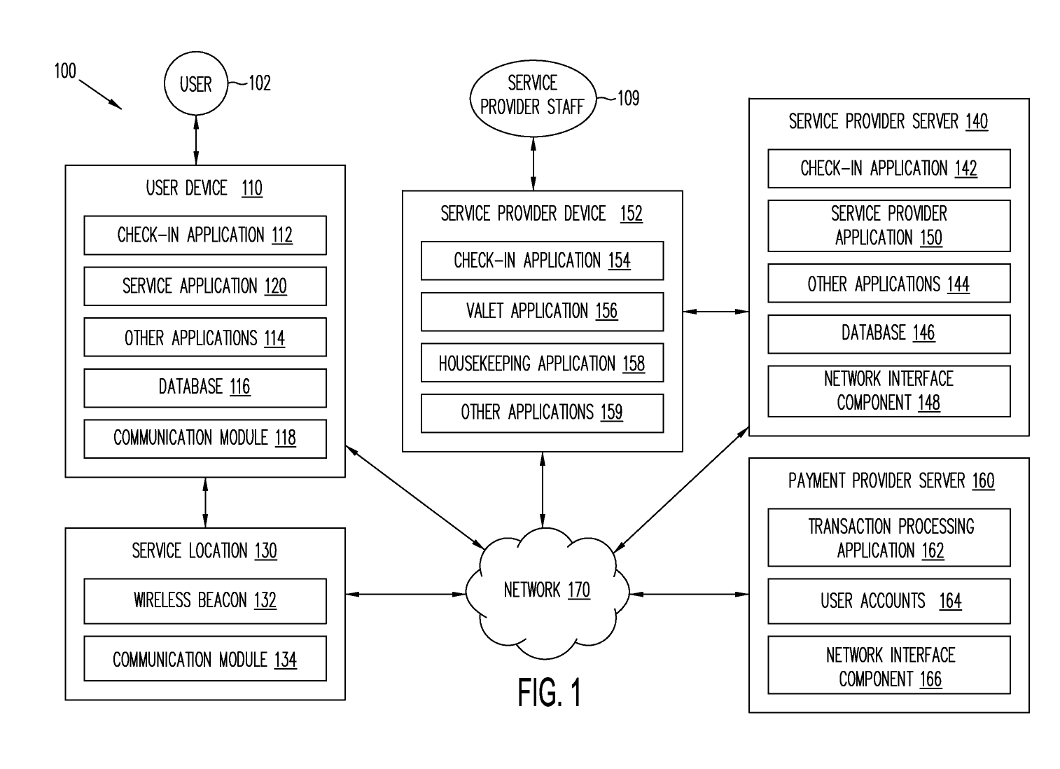

FIG. 1 is a block diagram of a networked system 100 suitable for implementing processes for facilitating hospitality services (e.g., hotel services), according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 may include one or more users such as user 102, each having a user device 110, a service location 130, a service provider server 140, one or more service provider staff members 109, each with access to one or more service provider devices such as service provider device 152, and a payment provider server 160 in communication over a network 170. Each user 102 (e.g., a visitor to a service location such as a hotel guest), may utilize their corresponding user device 110 to check-in to service provider server 140. Service location 130 may correspond to hotel, motel, resort, campground, timeshare, or other location that provides guest accommodations and/or other hospitality services. Service provider server 140 may correspond to a general server for multiple service locations (e.g. a server for a hotel chain) or may be specific to only service location 130 (e.g. a server for a particular hotel).

Check-in of users 102 may be accomplished through a beacon 132 (e.g., a wireless beacon) at service location 130, through a social media application or website or by other check-in equipment.

User device 110, service location 130, service provider device 152, and service provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

User device 110 may be implemented using any appropriate hardware and software such as hardware and software configured for wired and/or wireless communication with beacon 132 and service provider server 140. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOGGLE GLASS®) and/or other types of computing devices capable of transmitting and/or receiving data, such as an IPAD® from APPLE®. The user device may be managed or controlled by any suitable processing device.

As shown in FIG. 1, user device 110 may contain a check-in application 112, a service application 120, other applications 114, a database 116, and a communication module 118. Check-in application 112, service application 120, and other applications 114 may correspond to processes, procedures, and/or applications executable by a hardware processor, for example, a software program. In other embodiments, user device 110 may include additional or different software as required.

Check-in application 112 may be used by the user 102 of user device 110 to establish a connection between user device 110 and service provider server 140. Check-in application 112 may correspond to a specific application utilized by user device 110 with service provider server 140 to complete a check-in with service provider server 140. The check-in with service provider server 140 may correspond to a process to log in to a user account of user 102 with service provider server 140. In other embodiments, the check-in may provide and/or verify an identity of user 102, including transmission of an identifier for user 102 and/or user device 110. The check-in may be completed over network 170 with service provider server 140, In such embodiments, check-in application 112 may correspond more generally to a browser application configured to communicate with service provider server 140.

Check-in application 112 may also correspond to an application available over the Internet for download from service provider server 140 and/or other server corresponding to service location 130. Check-in application 112 may utilize communications module 118 to exchange short range wireless communications with beacon 132 at service location 130 to complete a check-in process. For example, service location 130 may include infrastructure with beacon 132 to communicate with user device 110 and complete the check-in process with service provider server 140. Beacon 132 may be configured to transmit an identifier for reception by user device 110.

Check-in application 112 may execute in the background of an operating system of user device 110 and be configured to establish connections, using communication module 118 of that user device 110, with one or more beacons 132 (e.g., wireless beacons) at service location 130. The connection may be established with or without user input from user 102. For example, beacon 132 may broadcast a token, such as a universally unique identifier (UUID), for reception by check-in application 112. Check-in application 112 may utilize communication module 118 of the user device 110 to receive the token from beacon 132. If check-in application 112 acknowledges the UUID as identifying service location 130, beacon 132, and/or service provider server 140, check-in application 112 may transmit an identifier corresponding to a user 102 and/or a user device 110 back to beacon 132. Check-in application 112 may utilize communication module 118 to communicate with beacon 132 (e.g., over near field communication, Bluetooth, Bluetooth Low Energy, radio, infrared, WiFi, cellular, GPS, combined cellular and GPS, microwave, a combination thereof, or other connection). The identifier from user device 110 may include, be transmitted with, concatenated with, or otherwise bundled with the identifier received from beacon 132.

Once a connection is established with beacon 132, user device 110 may be checked-in with service provider server 140 if the user 102 of that device has not previously been checked-in. The check-in process may then associate that user 102 with the beacon 132 used to check-in that user 102 and/or other wireless beacons at the service location. In such embodiments, check-in application 112 of user device 110 may utilize short range wireless communication with beacon 132, such as near field communication, Bluetooth, Bluetooth Low Energy, radio, infrared, WiFi, cellular, GPS, combined cellular and GPS, microwave, a combination thereof, or other connection. Where beacon 132 corresponds generally to service location 130 or a location in or around service location 130, user 102 may be associated with service location 130 or a particular location in or around service location 130, Thus, user 102 may be associated with the location of that beacon and/or other nearby beacons.

Check-in application 112 may receive information from service provider server 140. For example, check-in application 112 may receive information, maps, processes to request assistance from the service provider, etc. The information that is passed to check-in application 112 may be generally based on service location 130, such as a map of a hotel, hotel room status information, products and/or services that are offered for sale at service location 130 or other information about and/or associated with service location 130. Additionally, the service provider server 140 may determine a user history, purchase history, user preferences, and/or other user information corresponding to user 102 from a user identifier transmitted to service provider server 140 during the check-in process. Thus, the information may be transmitted to user 102 based on the user history and/or the other user information. When a user 102 is checked-in with service provider server 140, service provider server 140 may have an identifier of user device 110 and transmit the information to user device 110 using that identifier over network 170 and/or through one or more beacons 132.

Check-in application 112 may utilize communication module 118 to pass user information to service provider server 140, including user preferences, user calendar information, user relationship information, user email information, user social media information, user group membership information, user family information, user team information, identifiers of user 102 and/or user device 110, a request for assistance, a request for a type of assistance, product preference information, service preference information, etc.

Service application 120 may be used, for example, to provide a convenient interface to permit user 102 to receive, request, and/or view information, products and/or services. Service application 120 may correspond to an application specific to service location 130 and/or service provider server 140, such as an application downloadable over network 170 and/or through beacon 132. However, in other embodiments, service application 120 may correspond more generally to any application configured to receive information, targeted assistance, status updates, incentive offers, product offers, and/or service offers, including a browser application.

Service application 120 may also be configured to display the information. For example, service application 120 may display information for service location 130, such as a room number, a room status, or other information associated with a hotel or other hospitality location. Additionally, service application 120 may use a location device and/or application of user device 110, such as a GPS device and application in addition to or in place of beacon communications, to locate user 102 at a specific locations at and/or around service location 130, and transmit the specific location to service provider server 140 for use in providing the hospitality services, assistance, check-in information, check-out information, incentives, rewards, product offers and/or service offers. In other embodiments, the locations of user may be determined based on a check-in of user device 110 with various wireless beacons such as beacon 132 at various locations in and/or around service location 130.

Hospitality services, assistance, check-in information, check-out information, incentives, rewards, product offers and/or service offers may be provided to user 102 using a user device 110 of the user, and/or face to face by a salesperson, concierge, or other employee of service location 130 and may be provided in a preferred language of a user 102 or according other individual and/or group preferences or attributes. User preferences such as room preferences, room temperature preferences, water temperature preferences, room lighting preferences, housekeeping preferences, wake up preferences, or other preferences may be provided by users 102 (e.g., through typing in a preference request or selection of available preferences from a list) or may be learned by service application 120 or service provider server 140. Service application 120 may also receive and/or determine user preferences by scraping one or more online accounts of users 102 (e.g., a social networking account, a microblogging account, a user account with another service provider, etc.).

In various embodiments, check-in application 112 and service application 120 may be incorporated in the same application so as to provide their respective features in one convenient application interface.

User device 110 may include other applications 114 as may be desired in particular embodiments to provide features to user device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, or other applications. Other applications 114 may include browser and/or mapping applications where the functions are not provided by check-in application 112 and/or service application 120. Other applications 114 may contain software programs, executable by a processor, including a graphical user interface (GUI) configured to provide an interface to the user.

User device 110 may further include memory such as database 116 which may include, for example, identifiers such as operating system registry entries, cookies associated with check-in application 112, service application 120, and/or other applications 114, identifiers associated with hardware of user device 110, or other appropriate identifiers, such as identifiers used for payment/user/device authentication or identification. Database 116 may include user device tokens and/or encryption keys, including a public key of service location 130 and/or service provider server 140 for beacon 132. Database 116 may include identifying information for tokens enabling check-in application 112 to identify beacon 132 when receiving a corresponding token. In one embodiment, identifiers in database 116 may be used to associate user device 110 with a particular account maintained by the account provider. Database 116 may further include online account access information and/or shopping list information.

Each user device 110 may include a communication module 118 adapted to communicate with beacon 132, service provider server 140, and/or payment provider server 160. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, BLE, WiFi, cellular, GPS, combined cellular and GPS, microwave, near field communication devices, and/or a combination thereof. Communication module 118 may communicate directly with beacon 132 without network 170 using short range wireless communications.

Service location 130 may correspond to a physical location such as a hotel, a motel, a resort, a campground, timeshare, or other location that provides user accommodations and/or other hospitality services. Service location 130 may include a plurality of locations within service location 130, where each location includes a beacon such as a wireless beacon. For example, a location in service location 130 may correspond to a particular guest room, a particular floor of a hotel, a restaurant, a front desk, a portion of a front desk, a hotel lobby, a portion of a hotel lobby, a recreation area (e.g., a pool, patio, golf course, tennis court, gym, amusement park, video game arcade, etc), or a portion of a recreation area of a hotel (as examples).

Beacon 132 may check-in each user when the user device 110 of that user is in proximity to beacon 132. Thus, beacon 132 may enable service provider server 140 to associate a particular user 102 with service location 130 and/or a location within service location 130. Service location 130 may include a beacon 132 and a communication module 134. In other embodiments, service location 130 may include additional or different software and devices as required.

Beacon 132 may be maintained, for example, by service location 130 and service provider server 140. Beacon 132 may be implemented using any appropriate hardware and software configured for wireless communication with user device 110. For example, in one embodiment, beacon 132 may be implemented as a dongle device including a hardware processor and a communication module, for example, connected to device at service location 130. Thus, beacon 132 may be implemented as a device incorporated within or attached to a personal computer (PC), a smart phone, personal digital assistant (PDA), laptop computer, and/or other types of computing devices capable of transmitting and/or receiving data, such as an IPAD® from APPLE®. Beacon 132 may also act as a stand-alone device including a processor, communication module, and/or network interface component configured to communicate with user device 110 and/or service provider server 140, such as another smart phone communicating through LTE Direct. Although a single beacon is described, a plurality of beacons may be utilized and be location specific within service location 130, as previous discussed.

Beacon 132 of FIG. 1 may include processes, procedures, and/or applications executable by a hardware processor, for example, a software program, configured to interact with user devices 110. Beacon 132 may include applications for transmitting requests to establish a connection between a user device and beacon 132. Thus, beacon 132 may utilize a low energy short range wireless communication of beacon 132 to transmit requests to establish a connection with user devices 110, including an identifier such as a Universally Unique Identifier (UUID). If user devices 110 receive a request to establish the connection with beacon 132 and respond with a user device identifier (potentially including the UUID and other information to effectuate a check-in of each user device 110), beacon 132 may ramp up in power and create a connection between user devices 110 and beacon 132.

Beacon 132 may transmit the request to establish the connection with beacon 132 as a short range communication (e.g. a BLE protocol communication) including a “wake up” process for check-in applications 112 of user devices 110 and/or a token for beacon 132 or service provider server 140. In other embodiments, the request and/or connection may utilize near field communication, radio communication, infrared communication, or Bluetooth communication, BLE communication, WiFi communication, cellular communication, GPS communication, microwave communication, and/or any suitable combination thereof. The request may be specific to each user device 110 by including information that is specific to the corresponding user 102, such as a name, identifier, or user device identifier. The information specific to user 102 may be determined from user accounts of user 102 or other information previously provided to service provider server 140. Thus, in certain embodiments, only one or more specific user devices 110 will pick up and authenticate the request.

After beacon 132 receives user device identifiers from user devices 110 of user 102, beacon 132 may determine that user 102 is at or in proximity to service location 130. Beacon 132 may pass the user device identifier to service provider server 140 to complete the check-in process and associate user 102 with service location 130. As shown in FIG. 1, beacon 132 utilizes communication module 134 to pass the information to service provider server 140. However, in other embodiments, beacon 132 may utilize a network connection of beacon 132 through a communication module of beacon 132. Additionally, beacon 132 may keep a communication channel open between user devices 110 and service provider server 140 for passing additional information, such as assistance requests, a room number, a room status, incentives, rewards, assistance preferences, product and/or service offers, transaction information, payment information, and/or identification information.

In various embodiments, service location 130 includes at least one communication module 134 adapted to communicate with user devices 110, service provider server 140, and/or payment provider server 160. Communication module 134 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, BLE, cellular, GPS, combined cellular and GPS, microwave, near field communication devices, and/or any combination thereof. Communication module 134 may communicate directly with user device 110 without network 170 using short range wireless communications.

Service provider server 140 may be maintained, for example, by a service location including one or a plurality of service locations. Generally, service provider server 140 may be maintained by anyone or any entity that establishes and/or maintains a location with services, accommodations, and/or products offered to users. In this regard, service provider server 140 may include one or more applications, which may be configured to interact with user devices 110 and/or service location 130 to complete check-in processes for user devices 110. Although only one service provider server is shown, a plurality of service provider servers may be utilized. In various embodiments, the check-in and assistance features of service provider server 140 may also be offered by payment provider server 160. Thus, all or part of the described features and processes of service provider server 140 may be incorporated within payment provider server 160.

Service provider server 140 may include a check-in application 142, a service provider application 150, a database 146, and a network interface component 148. Check-in application 142 and service provider application 150 may correspond to processes, procedures, and/or applications executable by a hardware processor, for example, a software program. In other embodiments, service provider server 140 may include additional or different software as required.

Check-in application 142 may correspond to processes to complete check-in with user device 110. Thus, check-in application 142 may correspond to the server side application of service provider server 140 configured to transmit and/or receive check-in requests from user device 110 and complete the check-in requests. A check-in request may include log-in information for a user account in database 146. Check-in may be completed by verifying the account info nation. However, in embodiments where a user account has not been previously established by user 102 and/or service provider server 140 does not offer user account services, check-in application 142 may receive other information for identifying user 102, such as user names/identifiers, user device identifiers, group identifiers, an identifier for an account with another server (e.g., a payment account/payment account identifier with payment provider server 160), or other information.

Additionally, check-in application 142 may check user 102 out of the location when user 102 leaves the proximity of beacon 132. Checking user 102 out of a location may include checking the user out of the location corresponding to a particular beacon 132. In some embodiments, checkout of user 102 from one or more beacons 132 may initiate checkout of the user from a hotel. For example, in one embodiment, a user 102 may be determined to be leaving a hotel or have left the hotel for the last time (e.g., based on the user's detected movements determined based on check-in and checkout of various beacons and the user's checkout date and/or time) and the user may be may be checked-out of the hotel. In other embodiments, a user may be simply checked-out of the location within the hotel associated with that beacon without checking the user out of the hotel.

Service provider server 140 may include service provider application 150 configured to receive information corresponding to user 102 (e.g., a user identifier and/or other user information) that is checked-in to beacon 132 through service location 130 and provide hotel services, assistance, check-in information, check-out information, incentives, rewards, amenities control, concierge services, product offers and/or service offers to user 102.

Check-in information may correspond to one or more user accounts of user 102 with another server, such as payment provider server 160. In such embodiments, service provider server 140 may determine user information such as a user history and/or user preferences from information received from payment provider server 160. Payment provider server 160 may provide information about previous purchases/visits by user 102 at the same or similar locations to service location 130 or may provide other information.

In various embodiments, service provider server 140 may include other applications 144 as may be desired in particular embodiments to provide features to service provider server 140. For example, other applications 144 may include security applications for implementing server-side security features, programmatic server applications for interfacing with appropriate application programming interfaces (APIs) over network 170, or other types of applications. Other applications 144 may contain software programs, executable by a processor, including a graphical user interface (GUI), configured to provide an interface to a user.

Service provider server 140 may include a database 146 which may include, for example, identifiers such as operating system registry entries, cookies associated with check-in application 142 and/or service provider application 150, identifiers associated with hardware of service provider server 140, or other appropriate identifiers, such as identifiers used for payment/user/device authentication or identification. Database 146 may include identifiers and/or user accounts of user 102, which may comprise an identifier for users 102 and/or user devices 110. In various embodiments, identifiers in database 146 may be used by a payment/credit provider, such as payment provider server 160, to associate user 102 with a particular account maintained by payment provider server 160. For example, an identifier for a payment account with payment provider server 160 may be stored with a user account and/or identifiers of users 102 in database 146. In other embodiments, a user account stored in database 146 may include a shared identifier with the payment account with payment provider server 160.

In various embodiments, service provider server 140 includes at least one network interface component 148 adapted to communicate with user devices 110, service location 130, and/or payment provider server 160 over network 170. In various embodiments, network interface component 148 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, BLE, cellular, GPS, combined cellular and UPS, microwave, near field communication devices, and/or any combination thereof.

One or more staff members of the service location 130 such as service provider staff 109 may have access to one or more service provider devices such as service provider device 152. Service provider device 152 may be a mobile device such as a mobile phone, a tablet computer, a laptop computer, or a wearable computing device, or may be a stationary computing device such as a desktop computer or other suitable computing device. For example, service provider device 152 may be tablet computer associated with a valet parking service, a housekeeping service, or a concierge service of a hotel. Service provider device 152 may receive information associated with hotel guests such as guest locations, guest preferences, guest schedules, and/or information associated with guest rooms that helps service provider staff 109 and/or service provider server 140 provide associated services to the guest (e.g., user 102).

For example, service provider device 152 may be a valet device having a valet application 156 that can be accessed by a valet parking assistant and that provides notifications to the valet parking assistant that a hotel guest is in need of their vehicle. In another example, service provider device 152 may be a housekeeping device having a housekeeping application 158 that allows housekeeping staff to deter nine which hotel rooms are vacant and ready for cleaning. In another example, service provider device 152 may be a concierge device that provides guest preferences, guest purchases, guest party details or other information to the concierges when a particular guest approaches the concierge.

In one embodiment, service provider device 152 includes a check-in application 154 that allows the location of service provider device to be tracked by beacons 132. Service provider device 152 may include other applications 159 as described herein.

Payment provider server 160 may be maintained, for example, by an online payment service provider, which may provide user account and payment services on behalf of user 102 and other users. In this regard, payment provider server 160 includes one or more processing applications, which may provide payment for items using a user account with payment provider server 160. In one example, payment provider server 160 may be provided by PAYPAL®, Inc. of San Jose, Calif., USA. However, in other embodiments, payment provider server 160 may be maintained by or include a hotel, a merchant, financial services provider, and/or other service provider, which may provide user account services to user 102. Although payment provider server 160 is described as separate from service provider server 140, it is understood that payment provider server 160 may include services offered by service provider server 140 and vice versa.

Payment provider server 160 of FIG. 1 may include a transaction processing application 162, a database of user accounts 164, and a network interface component 166. Transaction processing application 162 may correspond to processes, procedures, and/or applications executable by a hardware processor, for example, a software program. In other embodiments, payment provider server 160 may include additional or different software as required.

Transaction processing application 162 may be configured to receive information from one or more user devices 110 and/or service provider server 140 for processing and completion of financial transactions. Transaction processing application 162 may include one or more applications to process financial transactions between user devices 110 and/or service provider server 140. Financial transactions may include financial information corresponding to user debit/credit card information, checking account information, a user account (e.g., payment account with payment provider server 160), or other payment information. Transaction processing application 162 may complete the financial transaction for the purchase request by providing payment to service provider server 140. In various embodiments, transaction processing application 162 may provide transaction histories, including receipts, to user device 110 in order to provide proof of purchase for an item and/or service. Transaction processing application 162 may also provide the transaction histories to service location 130 for use in pick-up/delivery of the item and/or service.

Additionally, payment provider server 160 includes user accounts 164. As previously discussed, user 102 may establish one or more user accounts with payment provider server 160. User accounts 164 may include user information, such as name, address, birthdate, payment/funding information, travel information, additional user financial information, and/or other desired user data. Information in user account 164 may be utilized by service provider server 140 to determine and provide hospitality services, product offers, alerts, and/or service offers to user 102.

In various embodiments, payment provider server 160 may include at least one network interface component 166 adapted to communicate with user device 110, service location 130, service provider device 152, and/or service provider server 140 over network 170. In various embodiments, network interface component 166 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), infrared (IR), BLE, cellular, GPS, combined cellular and GPS, microwave, and/or near field communication devices, and/or any combination thereof.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

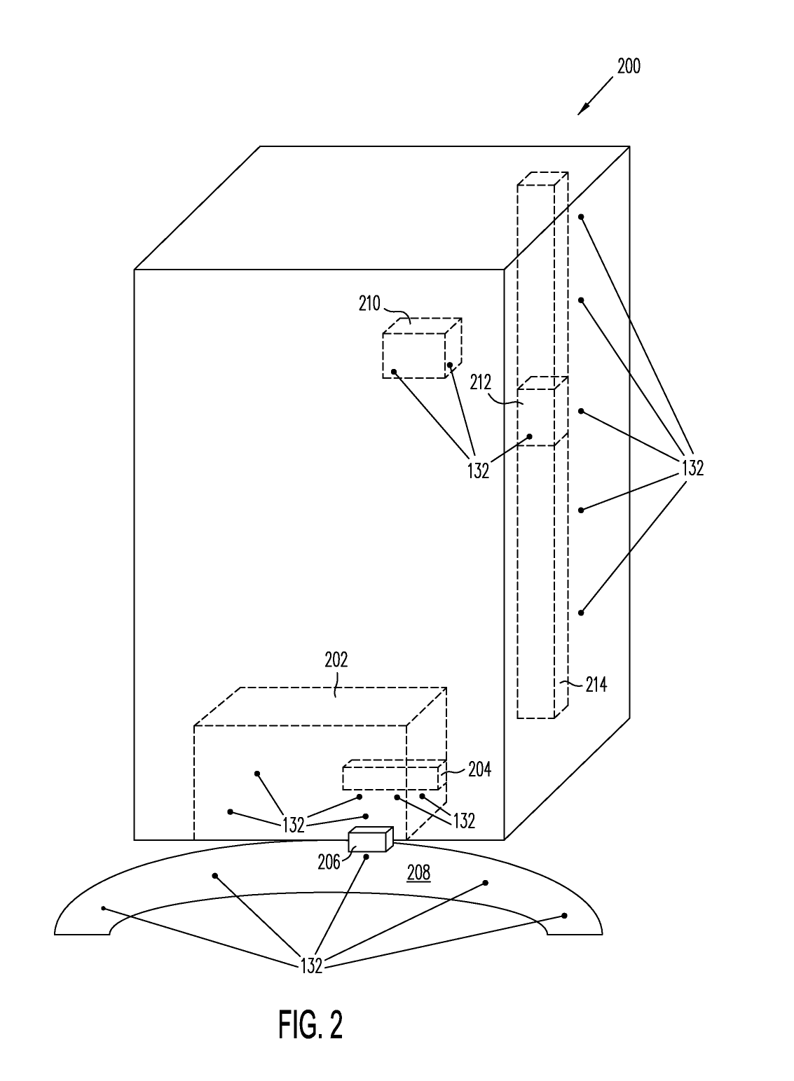

FIG. 2 is a diagram of an exemplary service location such as a hotel location having beacons. As shown in FIG. 2, a hotel 200 (e.g., a physical hotel location) may include one or more beacons 132. Although various examples are described herein in the context of a hotel and the providing of hotel services, it should be appreciated that the systems and methods provided herein can be applied to facilitate any similar hospitality services at any similar hospitality location such as a motel, resort, campground, timeshare, cruise ship, park, theme park, or other location that provides guest accommodations and/or other hospitality services.

Beacons 132 of hotel 200 may include one or more beacons 132 located at or near an entrance of the hotel such as beacons positioned at various locations near or within a driveway 208, a valet stand 206, a lobby 202, and/or a service desk 204 (e.g., a front desk, bell desk, concierge desk, etc.). Beacons 132 of hotel 200 may also include one or more beacons 132 located elsewhere in and/or around hotel 200 such as within an elevator 212, a guest room 210, along an elevator shaft 214 or other locations such as along hallways of each floor of a hotel, a convention or meeting area, a restaurant, a recreation area (e.g., a pool, patio, golf course, tennis court, gym, amusement park, video game arcade, etc.) (as examples).

As shown, multiple beacons 132 may be located within each area of the hotel so that the locations and/or motions of hotel guests can be determined even within each area. For example, in some situations, it may be desirable to determine that a particular guest is approaching a front desk, bell desk, or concierge desk (e.g., to initiate check-in, baggage retrieval or other services for the approaching guest) or crossing the lobby toward an exit (e.g., to initial car retrieval or checkout services). In some embodiments, one or more beacons 132 may be located within some or all of the guest rooms 210 of a hotel. A guest may use a beacon in the guest room and/or elsewhere in the hotel to pay for the guest room and/or other products and services at the hotel (e.g., using NFC communications between the user's device and the beacon). Beacons 132 in guest room 210 may be used to determine whether the guest is present in the room and/or to provide product and/or services offers and/or customized control of room amenities for that guest

For example, a housekeeping worker that wishes to clean the guest room may be able to determine, without knocking on or opening the hotel room door and thereby risking disturbing the guest, whether the room is vacant and can be cleaned. As another example, lighting or other amenities can be turned on or off and/or adjusted based on the guest's position and/or movement within the room. This can be particularly useful for guests with wearable electronic devices that remain with the guest even in the guest room and, potentially even in the shower (e.g., for waterproof devices). For example, when a guest approaches the shower, the shower can be turned on automatically in response to the approaching guest and the temperature, pressure, bathroom lighting and/or other associated amenities can be adjusted according to the guest's preferences.

In one embodiment, one or more beacons 132 may be carried or worn by hotel staff such as a hotel concierge (e.g., as part of a service provider device) so that beacon communications between the concierge beacon and a user device of an approaching guest may communicate so that guest details may pop up or otherwise be provided to the concierge including guest preferences, past purchases of the guest, the number of people in the guest's party and/or other suitable information for providing efficient services to the guest. In this way, for example, the concierge can have guest information at their disposal before the guest even reaches the concierge or concierge desk, and can, for example, greet each guest by name even if they have never before met the guest in person.

In general a hotel may include any suitable number and distribution of wired and/or wireless beacons in and/or around the hotel for tracking, detecting, or otherwise determining the locations of users such as users 102 in or around the hotel.

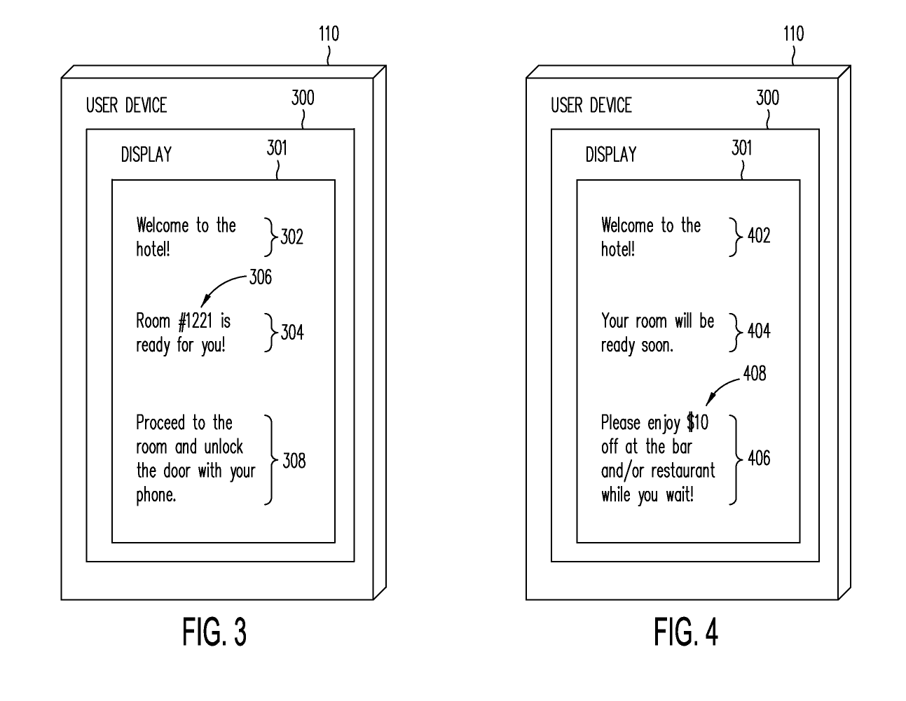

According to various embodiments, alerts or other notifications associated with hotel services that utilize beacons may be provided to a user such as a hotel guest on the user device of that guest before, during, and/or after their stay at the hotel. FIGS. 3 and 4 show illustrative examples of information that may be provided to a hotel guest on a user device of the guest.

In the example of FIG. 3, a user device having a guest room notification on a display of the user device is shown. As shown in FIG. 3, display 300 of user device 110 may be used provide a user with an application window 301 within which one or more notifications such as a greeting 302, a guest room notification 304, and/or guest instructions 308 may be provided. Notifications such as notifications 302, 304, and/or 308 may be provided in an application window as shown (e.g., a pop-up window) or may be provided in separate application windows, as text overlaid on an existing display image, or otherwise as desired.

As shown, a greeting notification 302 may include text such as “Welcome to the hotel!” or other suitable information for greeting a hotel guest when they arrive at the hotel either for the first time (e.g., for check-in) or after leaving and returning to the hotel. A guest room notification 304 may similarly be provided to the guest on user device 110 when the guest first arrives at the hotel or upon returning to the hotel and may include hotel check-in information (e.g., text such as “Room #1221 is ready for you!”) that informs the guest of the status of the hotel room and, if desired, a room number 306. This can be particularly convenient when guests are checking into the hotel for the first time and the room number and status can be provided in response to detection of the arrival of the guest using hotel beacons in communication with the user device of the guest. In this way, the guests can avoid waiting in line at the front desk and proceed directly to their room.

As an optional further convenience, the user's mobile device may be provided (e.g., via one or more beacons in communication with the user's device and upon checking the user into the hotel) with codes or other suitable security information so that the user's mobile device can be used to provide access to the guest's room or other secure portions (e.g., a gym, business center, pool, main entrance, side entrances, etc.) of the hotel property. Guest instructions notification 308 may therefore include instructions such as “Proceed to the room and unlock the door with your phone.” notifying the guest that they can access the guest room to which they have been checked in using their mobile phone as a key. For example, a beacon located in or around a secured entrance to a portion of a hotel such as a guest room (e.g., a beacon located near the door of the guest room) may recognize the user's phone when the user approaches the door, and based on the communication between the user's phone and the beacon, unlock and/or open the door. When a user's device is no longer in communication with that beacon (e.g., when the user leaves the hotel room) the beacon may also recognize that the user has left or is leaving and close and/or lock the door responsively. However, this is merely illustrative. A guest may be checked into the hotel and/or provided with guest room, welcome, and/or other notifications and may also be provided with a conventional physical or electronic room key if desired.

In the example of FIG. 3, the guest's room is ready and available upon arrival of the guest. However, in some situations, a guest's room may not be available (e.g., the room may not yet be ready for check-in or the housekeeping staff may be currently in the room cleaning) when the guest arrives at or returns to the hotel. FIG. 4 shows examples of notifications that may be provided to a guest on the guest's mobile device when the guest's room is not currently ready.

As shown in FIG. 4, when a guest's room is not ready, the guest may still be provided with a welcome notification 402 (e.g., “Welcome to the hotel!” or “Welcome back!”) and may also be provided with a guest room notification 404 and, if desired, an incentive or reward notification 406. For example, guest room notification 404 may include text such as “Your room will be ready soon.” or other suitable text notifying the guest of their room status. Room notification 404 may include additional information such as an estimated time that the room will be ready, an estimated amount of time until the room is ready, a reason the room is not ready (e.g., currently being cleaned, not yet check-in time, etc.) or other suitable information.

Because a room that is not ready can be a frustrating inconvenience for some guests in some situations, when the guest's room is not ready or available, a guest may be provided with an incentive or reward notification 406 such as text stating “Please enjoy $10 off at the bar and/or restaurant while you wait!” notifying the user of a discount or other offer to help the guest enjoy their time while they wait. An incentive notification 406 may include a currency amount 408 (e.g., $10), one or more locations (e.g., the bar and/or the restaurant) or other details of the guest incentive. The guest incentive may be determined based on the amount of inconvenience to the guest. For example, for a relatively short wait for a room to be prepared, a relatively small reward may be offered and for a relatively long wait, a relatively large reward may be offered. An incentive notification 406 may also include selectable options for the guest (e.g., $10 off at the bar or a 5% discount at the spa) from which the guest can choose. An additional alert may be provided to the user using display 300 when the guest's room is ready, notifying the guest that the room is available.

Notifications such as notifications 302, 304, 308, 402, 404, and/or 406 of FIGS. 3 and 4 may be provided to a particular guest when the guest is determined to be arriving or returning to the hotel as determined, for example, by wireless communications between a user device of the guest and one or more wireless beacons associated with the hotel. The text of notifications 302, 304, 308, 402, 404, and 406 of FIGS. 3 and 4 are merely illustrative and any suitable notification text, images, sounds, videos, vibrations, and/or other notification mechanism may be provided to alert a guest to a room number, room status, welcome information, incentives, rewards and/or other arrival information when the user arrives at the hotel.

Communications between a user device and one or more beacons such as wireless beacons at a hotel may also be used to provide information to hotel staff such as a valet assistant, a bell person, a concierge, housekeeping staff, or other hotel staff (e.g., based on a location or movement of the guest as determined using the wireless beacons).

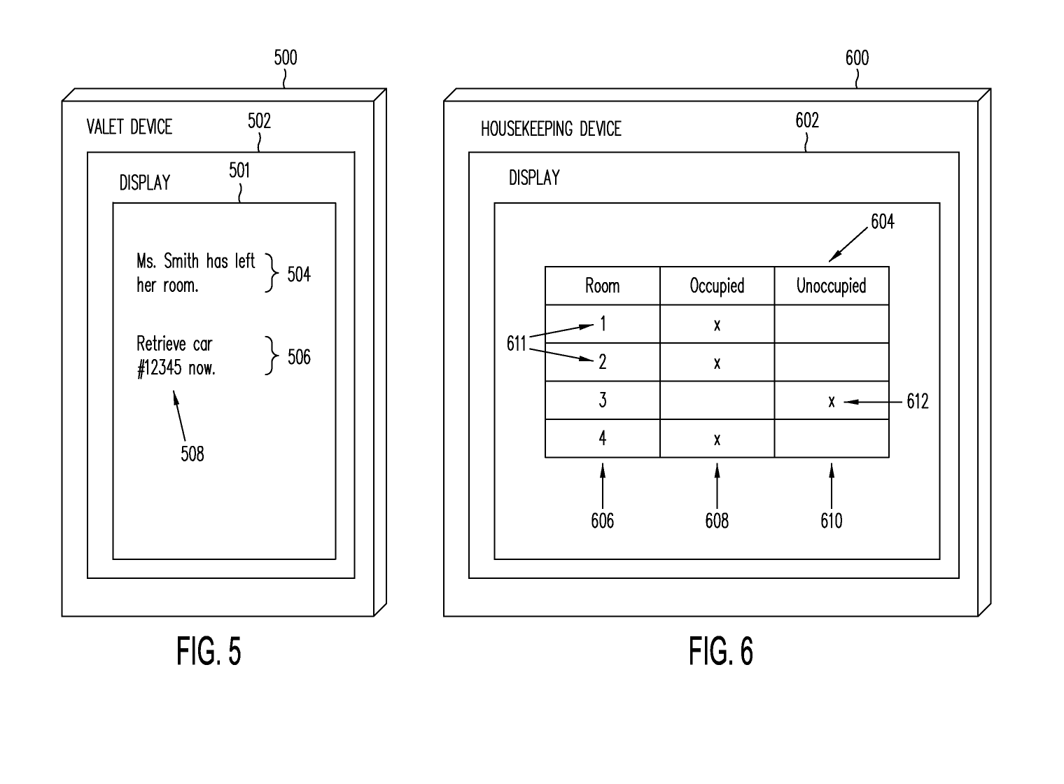

FIG. 5 shows an example of a valet device 500 having notifications for a valet assistant based on beacon communications with a user device. In the example of FIG. 5, a guest (e.g., Ms. Smith) leaves her guest room (e.g., as determined by one or more beacons in or near the hotel room) to pick up her car from the valet stand. Additional information such as an upcoming checkout time or a calendar event at a location away from the hotel on Ms. Smith's mobile phone may also be used to determine that the guest is in need of her car. When it is determined that Ms. Smith has left her room, a guest status alert 504 and a valet instruction notification 506 may be provided to the valet (e.g., in an application window 501 on the display 502 of the valet device 500.

As shown in FIG. 5, a guest status notification 504 may include text such as “Ms. Smith has left her room.” or other suitable text notifying the valet parking assistant of the status of the guest. A valet instruction notification 506 may include associated instructions for the valet parking assistant such as “Retrieve car #12345 now.” providing a vehicle identification 508 (e.g., vehicle #12345) for the guest's vehicle and instructions regarding what to do with the vehicle and when (e.g., retrieve the vehicle now). In this way, with little or no effort by the hotel guest, the hotel can seamlessly and efficiently provide the guest's car from valet parking without delaying the guest.

FIG. 6 shows an example of a housekeeping device 600 having guest room status information displayed for access by housekeeping staff based on guest status information determined using communications between guest user devices and one or more beacons at a hotel. Housekeeping device 600 may be a central device of a housekeeping manager or may be a mobile device that is carried with a housekeeping service worker as they move from guest room to guest room.

As shown in FIG. 6, a display 602 of housekeeping device 600 may be used to display the status (e.g., occupied or unoccupied) of each guest room or a subset of guest rooms in a hotel. In the example of FIG. 6, the room status of each room is presented in a table 604 having a room number column 606, an occupied column 608, and an unoccupied column 610. However, this is merely illustrative. In other embodiments, the status of each room or a subset of the rooms in a hotel may be presented in other formats and/or alerts or notifications regarding changes in room status may also be provided.

In the example of a tabular presentation, a table 604 may include the room number 611 of each room (e.g., rooms 1, 2, 3, and 4) and an indicator 612 in either the occupied column 608 or the unoccupied column 610, thereby indicating to the housekeeping staff which rooms are available for cleaning and which rooms are guest occupied. An indicator 612 may be moved from the occupied column to the unoccupied column when, for example, a mobile device of a guest that is in communication with a beacon in or near the guest room leaves the vicinity of that beacon and is checked out from that beacon. An indicator 612 may be moved from the unoccupied column to the occupied column when, for example, a mobile device of a guest begins communication with a beacon in or near the guest room.

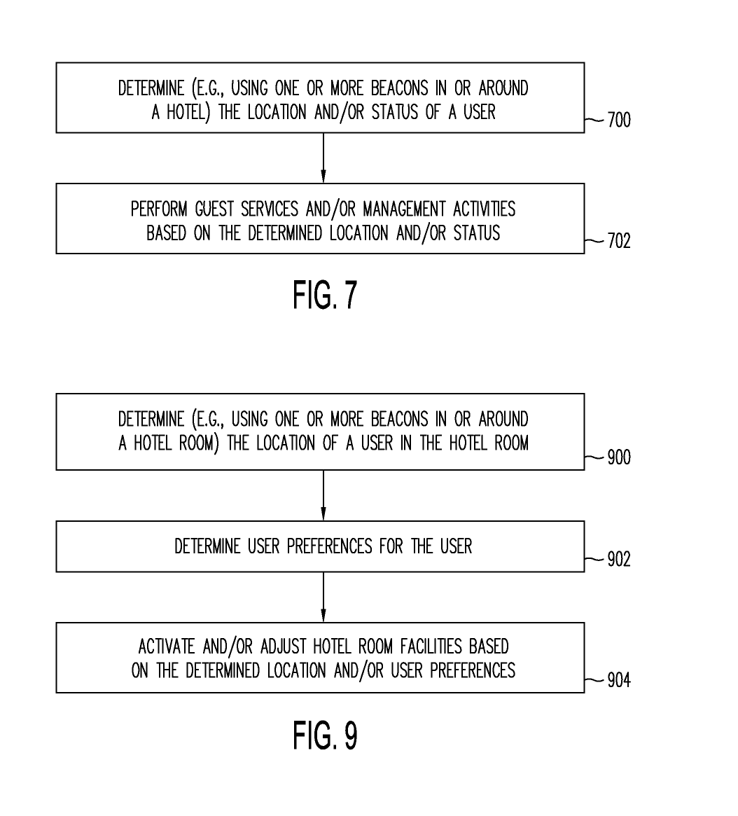

FIG. 7 is a flowchart of an exemplary process for facilitating hotel services using beacons, according to an embodiment.

At step 700, the location and/or status of a user such as a hotel guest may be determined using, for example, one or more beacons such as wireless beacons in or around the hotel. Determining the location and/or status may include receiving device check-in information from a user device of the user. Device check-in information from the user may include at least a user identifier for that user. The device check-in information may be provided through a social media application or website or may be received from a beacon corresponding to the location when the user device of the user is in communication with the beacon. The user device may be in communication with the beacon when the user device is in proximity to the beacon. The user device and the beacon may be in communication using one of near field communication, radio communication, infrared communication, Bluetooth communication, and Bluetooth low energy communication, cellular communication, GPS communication, combined cellular and GPS communication, microwave communication, and/or near field communication, and/or any combination thereof. The device check-in information may be received from the user when the user arrives at the location.

At step 702, guest services and/or guest management activities may be performed based on the determined location and/or status. Guest services and/or guest management activities may include providing a guest room number, a welcome, instructions, incentives, rewards, or other information or offers to the user, updating the status of the user's guest room, obtaining the user's car from a valet stand, greeting the user, checking the user into or out of the hotel, processing a payment for the user, adjusting or otherwise operating hotel amenities according to user preferences, providing security or access information to the user's device or otherwise servicing the guest as described herein.

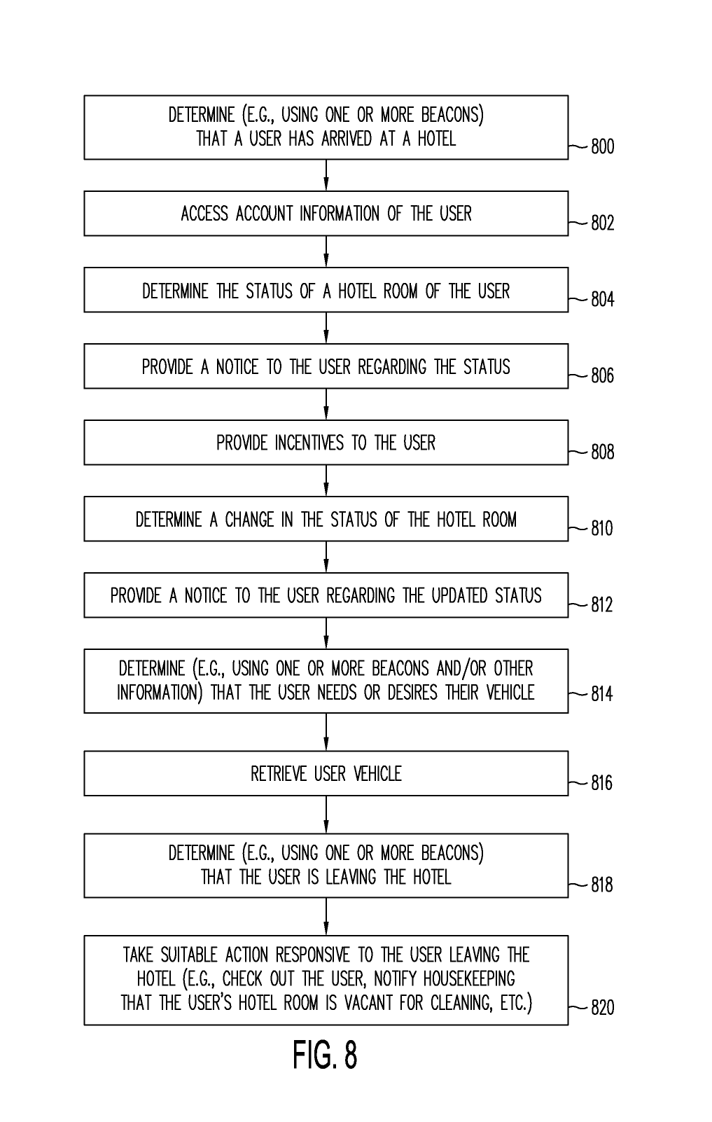

A more detailed example of operations that may be performed for providing hotel services to a hotel guest based on the location and/or status of the guest is shown in FIG. 8.

At step 800, it may be determined (e.g., using one or more beacons such as beacons in communication with a user device) that a user has arrived at a hotel. For example, beacons along or within the driveway, valet stand, lobby, front desk and/or other beacons may communicate with and track the arrival of the user. The user may be determined to be arriving for the first time (e.g., for hotel check in) or returning to the hotel.

At step 802, account information of the user may be accessed (e.g., from a hotel computer, a payment provider server, or other computing or storage equipment). The account information may include room reservation information, a cheek-in date, a check-out date, user payment account information, user preferences, and/or other information of the user. The account information may be accessed using check-in information received from the user's mobile device via one or more beacons at the hotel.

At step 804, the status of a hotel room of the user may be determined. In situations in which the user is arriving at the hotel for the first time, determining the status may include determining whether the room has been prepared (e.g., cleaned), determining whether the current time is earlier than, later than, or equal to the check-in time for the hotel room, determining whether hotel staff are currently in the room, and/or determining whether any special requests such as a turn down service, laundry service, or food and beverage service from the user for the hotel room have been met (as examples). In situations in which the user has already checked in to hotel and is returning to the hotel, determining the status may include determining whether the room has been prepared (e.g., cleaned), determining whether hotel staff are currently in the room, and/or determining whether any special requests from the user for the hotel room have been met (as examples).

At step 806, a notice may be provided to the user regarding the status of the hotel room. As examples, if it is determined that the room is ready for the user, one or more notices of the type shown in FIG. 3 may be provided or, if it is determined that the room is not ready for the user, one or more notices of the type shown in FIG. 4 may be provided. As described herein, the notice may be provided to a mobile device of the user via one or more beacons in communication with the mobile device (e.g., when the user parks, when the user enters the lobby, or any other suitable time before the user goes to the hotel room).

At step 808, one or more incentives or rewards may be provided to the user. For example, if it is determined that the hotel room is not ready for the user, a discount notice of the type shown in FIG. 4 or other incentive or reward notice may be provided to the user. The provided incentive may be determined based on an estimated or actual length of time until the hotel room is ready for the user. As described herein, the notice may be provided to a mobile device of the user via one or more beacons in communication with the mobile device.

At step 810, a change in the status of the hotel room of the user may be determined. For example, it may be determined that a room that was previously unavailable (e.g., not yet cleaned or otherwise prepared by housekeeping staff) is now available.

At step 812, an additional notice to the user may be provided regarding the change in status of the hotel room. For example, a notification may be provided via one or more beacons at the hotel informing the user that the room is ready (e.g., “Room #1221 is now ready!”).

At step 814, it may be determined (e.g., using one or more beacons and/or other information such as user calendar information) that the user needs or desires their vehicle. For example, a user that has parked in valet parking may be detected (e.g., using the beacons) at the valet stand, moving in the direction of the valet stand, leaving their hotel room, or otherwise located and/or moving in a manner that, alone or in combination with the other information, indicates that the user may need or desire their vehicle. In one example scenario, a user having a meeting calendared in their mobile device at a location away from the hotel at 3:00 PM may be detected leaving their hotel room at 2:45 PM. Based on location of the meeting and the proximity in time to the calendared event, a system such as a hotel server and/or a payment provider server may determine that the user is likely to drive to the event and therefore need their vehicle.

At step 816, the user's vehicle may be retrieved (e.g., from a valet parking location by a valet parking assistant). A valet parking assistant may receive a notification to retrieve the user's vehicle (e.g., via a valet device) when it is determined that the user needs or desired their vehicle.

At step 818, it may be determined (e.g., using one or more beacons such as beacons in communication with a user device) that the user is leaving the hotel. For example, beacons in or near the user's hotel room, along or within a hallway or elevator or elevator shaft, along or within the driveway, valet stand, lobby, front desk and/or other beacons may communicate with and track the motion of the user toward an exit or away from the hotel. The user may be determined to be leaving for the last time (e.g., for hotel check out) or leaving the hotel temporarily.

At step 820, suitable action may be taken responsive to the user leaving the hotel. For example, if it is determined (e.g., based on the checkout date and/or time of the user) that the user is leaving the hotel for the last time, the user may be checked out of the hotel. Whether the user is leaving for the last time or intends to return, when it is determined that the user is leaving or has left the hotel, a notification to housekeeping may be provided that the user's hotel room is vacant or unoccupied and is therefore available for cleaning. Suitable action responsive to the user leaving the hotel may include providing a “Thank you for staying with us!” message (for example), an offer for future stays, travel assistance or other notifications to the user's mobile device, retrieving the user's vehicle, sending a bell person to retrieve the user's luggage, calling a taxi or shuttle, or otherwise providing exit services to the user.

As described herein, one or more beacons may be used to determine a user's location within a hotel room of the user or other portion of a hotel. Various hotel amenities can then be controlled based on the user's location, movement, and/or other information such as user preferences. FIG. 9 is a flowchart of an exemplary process for controlling hotel amenities using beacons, according to an embodiment.

At step 900, the location of a user within a hotel room or within another portion of a hotel having controllable amenities (e.g., a spa, restroom, etc.) may be determined (e.g., using one or more beacons in or around the hotel room such as beacons in communication with a user device such a wearable device). For example, it may be determined that a particular user is in a particular portion of a hotel room, at a bathroom sink, entering a shower, etc.

At step 902, user preferences for the user may be determined. For example, stored preferences of a user associated with a user account of the user may be accessed. Stored preferences may be user-provided preferences and/or learned preferences (e.g., based on a user history, purchase history, etc.).

At step 904, amenities such as hotel room facilities (e.g., a water faucet temperature control, a lighting control, a room temperature control, a humidity control, a music control, a television control, etc.) may be activated and/or adjusted based on the determined location and/or the user preferences. In one example, when it is determined that one user is sitting on one bed of a hotel room and another user is sitting on another bed of the hotel room, the user preferences for lighting and temperature for each user may be retrieved from stored user accounts of each user and the temperature and lighting of the portion of the room around each bed can be adjusted according to the user preferences of the user sitting on that bed. In another example, when it is determined that a user has entered or is entering a hotel room shower, the shower faucet may be turned on and the water temperature and/or pressure may be set to the preferred temperature and/or pressure of that user, according to stored preferences in that user's account.

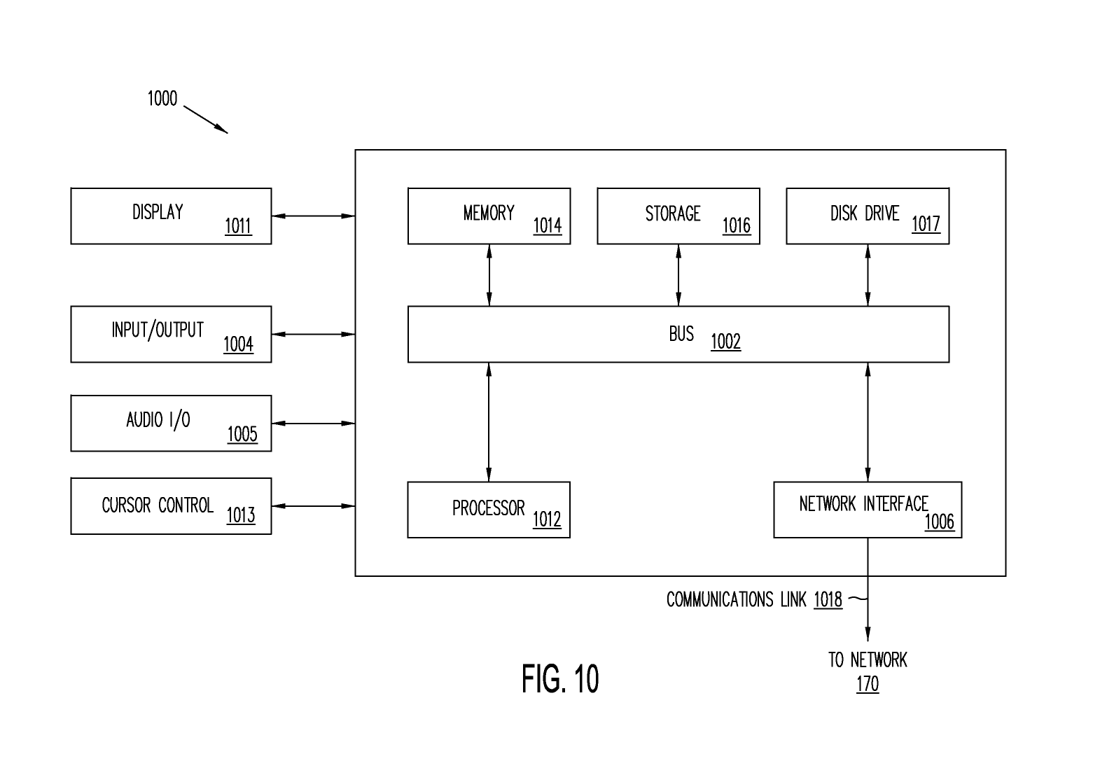

FIG. 10 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant device and/or service provider may utilize a network computing device (e.g., a network server) capable of communicating with the network. It should be appreciated that each of the devices utilized by users and service providers may be implemented as computer system 1000 in a manner as follows.

Computer system 1000 includes a bus 1002 or other communication mechanism for communicating information data, signals, and information between various components of computer system 1000. Components include an input/output (I/O) component 1004 that processes a user action, such as selecting keys from a keypad/keyboard, selecting one or more buttons, image, or links, and/or moving one or more images, etc., and sends a corresponding signal to bus 1002. I/O component 1004 may also include an output component, such as a display 1011 and a cursor control 1013 (such as a keyboard, keypad, mouse, etc.). An optional audio input/output component 1005 may also be included to allow a user to use voice for inputting information by converting audio signals. Audio I/O component 1005 may allow the user to hear audio. A transceiver or network interface 1006 transmits and receives signals between computer system 1000 and other devices, such as another user device, a merchant device, or a service provider server via network 170. In one embodiment, the transmission is wireless, although other transmission mediums and methods may also be suitable. One or more processors 1012, which can be a micro-controller, digital signal processor (DSP), or other processing component, processes these various signals, such as for display on computer system 1000 or transmission to other devices via a communication link 1018. Processor(s) 1012 may also control transmission of information, such as cookies or IP addresses, to other devices.

Components of computer system 1000 also include a system memory component 1014 (e.g., RAM), a static storage component 1016 (e.g., ROM), and/or a disk drive 1017. Computer system 1000 performs specific operations by processor(s) 1012 and other components by executing one or more sequences of instructions contained in system memory component 1014. Logic may be encoded in a computer readable medium, which may refer to any medium that participates in providing instructions to processor(s) 1012 for execution. Such a medium may take many forms, including but not limited to, non-volatile media, volatile media, and transmission media. In various embodiments, non-volatile media includes optical or magnetic disks, volatile media includes dynamic memory, such as system memory component 1014, and transmission media includes coaxial cables, copper wire, and fiber optics, including wires that comprise bus 1002. In one embodiment, the logic is encoded in non-transitory computer readable medium. A non-transitory computer-readable medium may include instructions which, in response to execution by a computer system, cause the computer system to perform some or all of one or more methods as described herein. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 1000. In various other embodiments of the present disclosure, a plurality of computer systems 1000 coupled by communication link 1018 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a hardware memory storing account information associated with a hotel guest of a hotel; and
one or more hardware processors in communication with the hardware memory and configured to:
determine a location of the hotel guest in or around the hotel based on communications between a mobile device of the hotel guest and one or more beacons in or around the hotel; and
provide guest services to the hotel guest based on the determined location.

2. The system of claim 1, wherein the one or more hardware processors are configured to provide the guest services by providing a notification to the mobile device of the hotel guest regarding the status of a room of the hotel guest when the hotel guest arrives at the hotel.

3. The system of claim 2, wherein the notification comprises a room number and hotel check-in information.

4. The system of claim 2, wherein the notification comprises:
information indicating that the room is not available; and
an incentive notification for the hotel guest.

5. The system of claim 4, wherein the incentive notification comprises a discount for the hotel guest.

6. The system of claim 1, wherein the location comprises a location within a guest room of the hotel guest and wherein the one or more hardware processors are configured to provide the guest services by adjusting one or more room amenities based on the location within the guest room and at least one preference of the hotel guest.

7. The system of claim 6, wherein the one or more room amenities include lighting in the room, a temperature of the room, television channel presents, and a water temperature.

8. The system of claim 1, wherein the one or more hardware processors are further configured to:
determine that the hotel guest is leaving the hotel; and
provide the guest services by instructing a valet parking assistant to retrieve a vehicle of the hotel guest based on the determination that the hotel guest is leaving.

9. The system of claim 1, wherein the one or more hardware processors are further configured to determine that the hotel guest is leaving the hotel based on a determined movement of the hotel guest and calendar information of the hotel guest.

10. The system of claim 1, wherein the one or more hardware processors are configured to provide the guest services by:
determining whether a guest room of the hotel guest is occupied by the hotel guest; and
providing guest room status information to housekeeping staff of the hotel indicating whether the guest room is occupied.

11. The system of claim 1, wherein the location comprises a location within the proximity of a hotel concierge having at least one of the one or more beacons and wherein the one or more hardware processors are configured to provide the guest services by providing guest information of the hotel guest to the hotel concierge as the hotel guest approaches the hotel concierge.

12. The system of claim 1, further comprising the one or more beacons, wherein at least one of the beacons is located adjacent to a driveway, a valet stand, a lobby, an elevator or a guest room of the hotel.

13. The system of claim 1, wherein the one or more hardware processors are configured to determine the location of the hotel guest when the mobile device of the hotel guest is in proximity to a wireless beacon at the hotel and in communication with the wireless beacon using one of near field communication, radio communication, infrared communication, Bluetooth communication, cellular communication, global positioning system communication, and Bluetooth low energy communication.

14. A method comprising:
storing, electronically by a hardware memory, account information associated with a hotel guest of a hotel;
determining, electronically by one or more hardware processors, a location of the hotel guest in or around the hotel based on communications between a mobile device of the hotel guest and one or more beacons in or around the hotel; and
providing, electronically by the one or more hardware processors, guest services to the hotel guest based on the determined location.

15. The method of claim 14, wherein the determining comprises determining that the hotel guest has arrived at the hotel and wherein the providing comprises:
checking the hotel guest into the hotel responsive to the determining; and
providing a room number and a room status to the hotel guest.

16. The method of claim 14, wherein the determining comprises determining that the hotel guest has arrived at the hotel and wherein the providing comprises:
providing a notification to the hotel guest that a room of the hotel guest is not available;
providing an estimated time when the room will be available to the hotel guest; and
providing an incentive notification to the hotel guest.

17. The method of claim 16, further comprising determining the incentive notification based on the estimated time when the room will be available.

18. A non-transitory computer-readable medium comprising instructions which, in response to execution by a computer system, cause the computer system to perform a method comprising:
storing account information associated with a hotel guest of a hotel;
determining a location of the hotel guest in or around the hotel based on communications between a mobile device of the hotel guest and one or more beacons in or around the hotel; and
providing guest services to the hotel guest based on the determined location.

19. The non-transitory computer-readable medium of claim 18, wherein the determining comprises determining that the hotel guest is leaving or has left a hotel room of the hotel guest and wherein the providing comprises providing a notification to a valet device to retrieve a vehicle of the hotel guest responsive to the determining.

20. The non-transitory computer-readable medium of claim 18, wherein the determining comprises determining whether the hotel guest is in a hotel room of the hotel guest and wherein the providing comprises providing information indicating whether the hotel room is occupied to a housekeeping device responsive to the determining.
